(19) United States
(12) Patent Application Publication
(10) Pub. No.: US 2024/0088617 A1
(43) Pub. Date: Mar. 14, 2024

(54) JOINING METHOD OF ELECTRIC WIRES AND JOINING STRUCTURE OF ELECTRIC WIRES

(71) Applicant: Yazaki Corporation, Tokyo (JP)

(72) Inventors: Syunsuke Yaoita, Shizuoka (JP); Yosuke Takayashiki, Shizuok (JP)

(73) Assignee: Yazaki Corporation, Tokyo (JP)

(21) Appl. No.: 18/367,070

(22) Filed: Sep. 12, 2023

(30) Foreign Application Priority Data
Sep. 14, 2022 (JP) 2022-146068

(51) Int. Cl. H01R 43/033; H01R 43/02

(52) U.S. Cl. CPC H01R 43/0335; H01R 43/0207

(57) ABSTRACT

A joining method of electric wires includes peeling off an insulation sheath of each of a plurality of electric wires at a part of each of the electric wires to expose core wires having been twisted of each of the electric wires, untwisting the exposed core wires of each of the electric wires, and joining untwisted core wires of the electric wires together in a bundle.

### CROSS-REFERENCE TO RELATED APPLICATIONS

The present application is based on and claims the benefit of priority from the prior Japanese Patent Application No. 2022-146068, filed on Sep. 14, 2022, the entire contents of which are incorporated by reference herein.

### TECHNICAL FIELD

The disclosure relates to a joining method of electric wires and a joining structure of electric wires.

### BACKGROUND

As a joining method of electric wires, there has been known an ultrasonic joining method described in Patent Document 1 (JP 2007-149421 A). In the ultrasonic joining method described in Patent Document 1, core wires of respective electric wires are firstly exposed by peeling off sheaths of the respective electric wires at parts (one ends) of the respective electric wires. Next, in a state where a core wire bundle, which is composed of a plurality of core wires of the electric wires, is held between an upper mold and a lower mold and between a left mold and a right mold while applying a pressure to the core wire bundle, the plurality of core wires of the electric wires is joined together by ultrasonic by giving ultrasonic vibration to the plurality of core wires of the electric wires.

### SUMMARY

In the conventional joining method of electric wires, in order to solve a problem of breaking of a core wire, fraying of joined core wires, or the like due to non-uniformity in strength of vibration applied to the plurality of core wires of the electric wires, a weak pressure is applied to the plurality of core wires of the electric wires to make them adhere together before ultrasonic joining.

However, in a case where core wires are twisted in each of electric wires, or in a case where a plurality of core wires of the electric wires is not uniformly deformed due to a condition where core wires of one electric wire and core wires of another electric wire are made of different materials such as copper and aluminum with different strengths, one electric wire and another electric wire have different diameters or the like, there is a possibility that the above-described method does not always make the plurality of core wires of the electric wires adhere together evenly.

The disclosure has been made in view of such a conventional problem, and it is an object of the disclosure to provide a joining method of electric wires and a joining structure of electric wires capable of decreasing gaps among core wires to be joined, and always making a plurality of core wires of the electric wires adhere together evenly.

A joining method of electric wires in accordance with a first aspect includes: a j oining method of electric wires comprising: peeling off an insulation sheath of each of a plurality of electric wires at a part of each of the electric wires to expose core wires having been twisted of each of the electric wires; untwisting the exposed core wires of each of the electric wires; and joining untwisted core wires of the electric wires together in a bundle.

A joining structure of electric wires in accordance with a second aspect includes: a joining structure of electric wires comprising: a plurality of electric wires each of which includes core wires being exposed at a part of each of the electric wires by peeling off an insulation sheath of each of the electric wires at the part of each of the electric wires and being untwisted, wherein untwisted core wires of the electric wires are joined together in a bundle.

According to the disclosure, it is possible to provide a joining method of electric wires and a joining structure of electric wires capable of decreasing gaps among core wires to be joined, and always making a plurality of core wires of the electric wires adhere together evenly.

### BRIEF DESCRIPTION OF DRAWINGS

FIG. 1 is a schematic diagram of an ultrasonic joining apparatus used in a joining method of electric wires according to a first embodiment.

FIG. 2A is a perspective view of an electric wire illustrating a state before core wires made of aluminum or aluminum alloy are untwisted, in the first embodiment.

FIG. 2B is a perspective view of an electric wire illustrating a state before core wires made of copper or copper alloy are untwisted, in the first embodiment.

FIG. 3A is a perspective view of the electric wire illustrating a state after the core wires made of aluminum or aluminum alloy are untwisted, in the first embodiment.

FIG. 3B is a perspective view of the electric wire illustrating a state after the core wires made of copper or copper alloy are untwisted, in the first embodiment.

FIG. 4A is an explanatory diagram illustrating a state where four electric wires are joined to one another by ultrasonic using the joining method of electric wires according to the first embodiment, the four electric wires being classified into two types in which material strengths of core wires are different under a condition where diameters of electric wires are same.

FIG. 4B is an explanatory diagram illustrating a state where four electric wires are joined to one another by ultrasonic using the conventional joining method of electric wires, the four electric wires being classified into two types in which material strengths of core wires are different under a condition where diameters of electric wires are same.

FIG. 5 is a side view illustrating a state where the four electric wires are joined to one another by ultrasonic, in the first embodiment.

FIG. 6 is a side view of a wire harness including the four electric wires, in the first embodiment.

FIG. 7 is a schematic diagram of an ultrasonic joining apparatus used in a joining method of electric wires according to a second embodiment.

FIG. 8A is a perspective view of an electric wire having a small diameter illustrating a state before core wires made of aluminum or aluminum alloy are untwisted, in the second embodiment.

FIG. 8B is a perspective view of an electric wire having a large diameter illustrating a state before core wires made of aluminum or aluminum alloy are untwisted, in the second embodiment.

FIG. 9A is a perspective view of the electric wire having the small diameter illustrating a state after the core wires made of aluminum or aluminum alloy are untwisted, in the second embodiment.

FIG. 9B is a perspective view of the electric wire having the large diameter illustrating a state after the core wires made of aluminum or aluminum alloy are untwisted, in the second embodiment.

FIG. 10A is an explanatory diagram illustrating a state where four electric wires are joined to one another by ultrasonic using the joining method of electric wires according to the second embodiment, the four electric wires being classified into two types in which diameters of electric wires are different under a condition where material strengths of core wires are same.

FIG. 10B is an explanatory diagram illustrating a state where four electric wires are joined to one another by ultrasonic using the conventional joining method of electric wires, the four electric wires being classified into two types in which diameters of electric wires are different under a condition where material strengths of core wires are same.

FIG. 11 is a side view illustrating a state where the four electric wires are joined to one another by ultrasonic, in the second embodiment.

FIG. 12 is a side view of a wire harness including the four electric wires, in the second embodiment.

### DETAILED DESCRIPTION

Hereinafter, a joining method of electric wires and a joining structure of electric wires according to embodiments will be described in detail with reference to the drawings.

Firstly, an ultrasonic joining apparatus 1 used in a joining method of electric wires according to a first embodiment will be described.

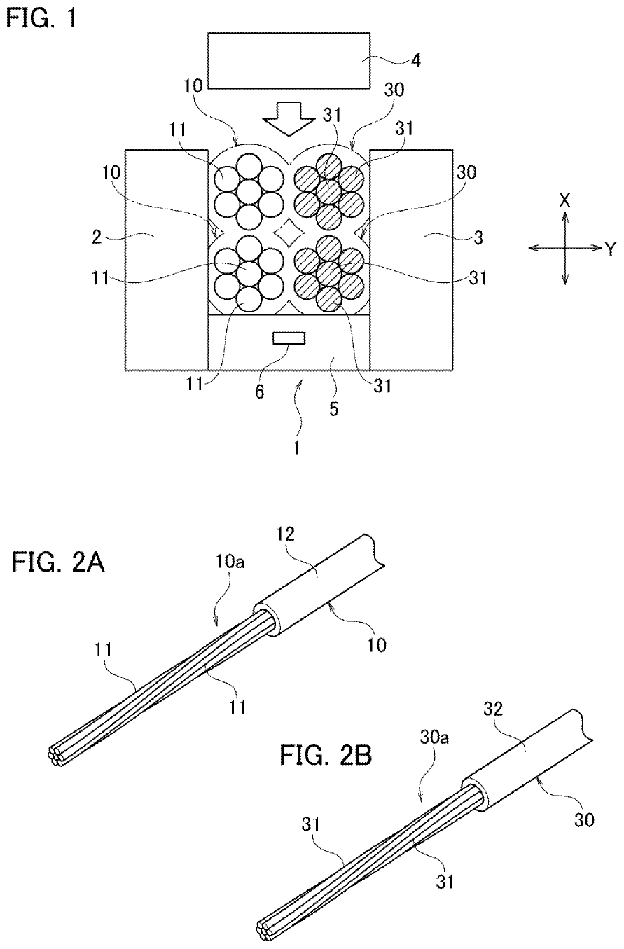

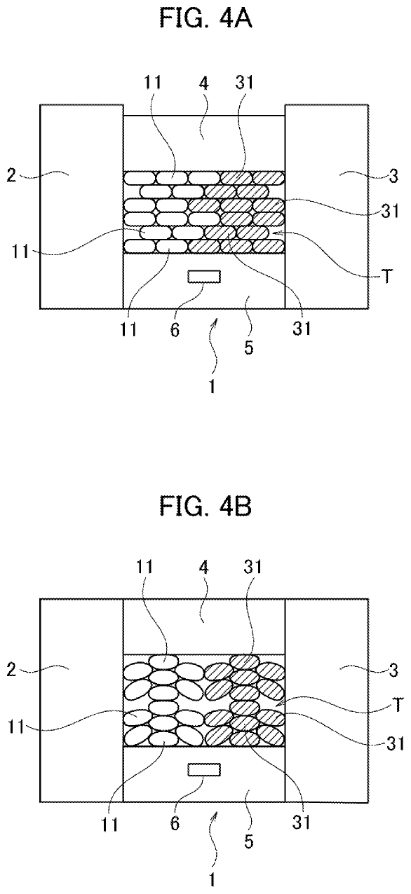

As illustrated in FIG. 1 and FIG. 4A, the ultrasonic joining apparatus 1 includes a pair of a left mold 2 and a right mold 3 and a pair of an upper mold 4 and a lower mold 5. Four core wire bundles which are respectively composed of core wires 11 of one electric wire 10, core wires 11 of the other electric wire 10, core wires 31 of one electric wire 30, and core wires 31 of the other electric wire 30, are held between the left mold 2 and the right mold 3 in a horizontal direction Y, and between the upper mold 4 and the lower mold 5 in a vertical direction X perpendicular to the horizontal direction Y.

In the first embodiment, the upper mold 4 moves toward the lower mold 5 in a direction approaching the lower mold 5 to apply a pressure to the core wire bundles. The left mold 2 and the right mold 3 are fixed to the lower mold 5. Alternatively, the left mold 2 and the right mold 3 can be configured to move in the horizontal direction Y such that they approach each other on the lower mold 5, to apply a pressure to the core wire bundles. It is noted that the number of the electric wires 10 is not limited to two and the number of the electric wires 30 is not limited to two.

As illustrated in FIG. 1, a piezoelectric vibrator 6 is mounted to the lower mold 5 as ultrasonic joining means. The piezoelectric vibrator 6 to which a voltage is applied by a power supply or the like (not illustrated), vibrates with a frequency of 10 kHz to 80 kHz as ultrasonic vibration, for example. At this time, the piezoelectric vibrator 6 performs ultrasonic joining along the horizontal direction Y or the vertical direction X. It is noted that the ultrasonic joining refers to joining using a vibration obtained by applying a voltage to the piezoelectric vibrator 6 to cause the piezoelectric vibrator 6 to vibrate, that is, by converting electrical energy into mechanical vibrations. The vibration is controlled by a control circuit (not illustrated).

The ultrasonic joining apparatus 1 joins a plurality of core wires 11 of the two electric wires 10, 10 and a plurality of core wires 31 of the two electric wires 30, 30 together. Each of the two electric wires 10, 10 is an aluminum wire with the core wires 11 made of aluminum or aluminum alloy covered with an insulation sheath 12. Each of the two electric wires 30, 30 is a copper wire with the core wires 31 made of copper or copper alloy covered with an insulation sheath 32, and has the same diameter as the aluminum wire (each of the two electric wires 10, 10). Namely, the ultrasonic joining apparatus 1 joins the plurality of core wires 11 of the two electric wires 10, 10 and the plurality of core wires 31 of the two electric wires 30, 30 together by ultrasonic, in a state where the two electric wires 10, 10 have the same diameters as the two electric wires 30, 30 and the material strengths of the core wires 11 differ from the material strengths of the core wires 31.

Next, a procedure of joining the plurality of core wires 11 of the two electric wires 10, 10 and the plurality of core wires 31 of the two electric wires 30, 30 together using the ultrasonic joining apparatus 1, will be described with reference to FIG. 1 to FIG. 4A.

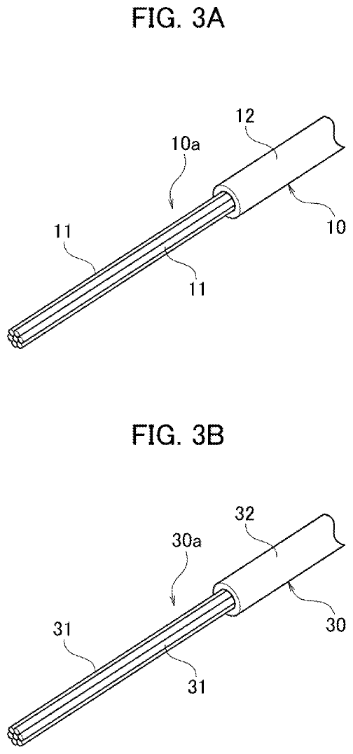

Firstly, as illustrated in FIG. 2A and FIG. 2B, the insulation sheath 12 of each of the two electric wires 10, 10 is peeled off in a little longer, at one end (part) 10a of each of the two electric wires 10, 10, and the insulation sheath 32 of each of the two electric wires 30, 30 is peeled off in a little longer, at one end (part) 30a of each of the two electric wires 30, 30. Next, as illustrated in FIG. 3A and FIG. 3B, the core wires 11, which have been twisted, exposed at the one end (part) 10a of each the two electric wires 10, 10 are untwisted to be straight, and the core wires 31, which have been twisted, exposed at the one end (part) 30a of each the two electric wires 30, 30 are untwisted to be straight.

Next, as illustrated in FIG. 1, the four core wire bundles which are respectively composed of the straight core wires 11 being untwisted of one electric wire 10, the straight core wires 11 being untwisted of the other electric wire 10, the straight core wires 31 being untwisted of one electric wire 30, and the straight core wires 31 being untwisted of the other electric wire 30, are inserted in a space surrounded by the left mold 2, the right mold 3 and the lower mold 5 from above, and then held between the left mold 2 and the right mold 3. Then, as illustrated in FIG. 4A, the plurality of straight core wires 11 and the plurality of straight core wires 31 are joined to one another by ultrasonic by giving ultrasonic vibration to the plurality of straight core wires 11 and the plurality of straight core wires 31 while applying a pressure to the core wire bundles by moving the upper mold 4 toward the lower mold 5. At this time, since the plurality of straight core wires 11 are untwisted and the plurality of straight core wires 31 are untwisted, each of the core wires 11 and each of the core wires 31 can easily move in a space surrounded by the left mold 2, the right mold 3, the upper mold 4 and the lower mold 5, with comparison with the plurality of core wires 11 having been twisted and the plurality of core wires 31 having been twisted as illustrated in FIG. 4B.

Conventionally, gaps between the core wires 11 of one electric wire 10 and the core wires 11 of the other electric wire 10, between the core wires 31 of one electric wire 30 and the core wires 31 of the other electric wire 30, and between the core wires 11 of each electric wire 10 and the core wires 31 of each electric wire 30, are filled a little by deforming the core wire bundles, as illustrated in FIG. 4B. In contrast, in this embodiment, these gaps are filled by moving and deforming each of the core wires 11 and each of the core wires 31 by applying a pressure to the core wire bundles using the upper mold 4. Thus, vibration can be applied to the plurality of core wires 11 and the plurality of core wires 31 in a state of no more gaps between the core wires 11 of one electric wire 10 and the core wires 11 of the other electric wire 10, between the core wires 31 of one electric wire 30 and the core wires 31 of the other electric wire 30, and between the core wires 11 of each electric wire 10 and the core wires 31 of each electric wire 30 than before. This allows the plurality of core wires 11 and the plurality of core wires 31 to be joined into a bundle-like rectangular cross-sectional shape (uniformly adhered core wire bundle T) with no gaps, as quickly as possible. In addition, vibration is transmitted evenly to each of the core wires 11 and each of the core wires 31, which ensures that the plurality of core wires 11 and the plurality of core wires 31 are joined without breaking of a core wire, fraying of j oined core wires, or the like.

As described above, in a case where the two electric wires 10, 10 have the same diameters as the two electric wires 30, 30 and the material strengths of the core wires 11 differ from the material strengths of the core wires 31, the conventional method deforms each of the core wires 11 and each of the core wires 31 by applying a pressure to the core wire bundles using the upper mold 4 or applying a pressure to the core wire bundles before joining the core wires 11 and the core wires 31 together. However, since the exposed core wires 11 of each electric wire 10 have been twisted and the exposed core wires 31 of each electric wire 30 have been twisted, the core wires 11 of each electric wire 10 and the core wires 31 of each electric wire 30 have been respectively bound as core wire bundles. Due to this, as illustrated in FIG. 4B, gaps between the core wires 11 and the core wires 31 easily occur.

In contrast, in this embodiment, since the exposed core wires 11 of each electric wire 10 are untwisted to be straight and the exposed core wires 31 of each electric wire 30 are untwisted to be straight, the core wires 11 of each electric wire 10 and the core wires 31 of each electric wire 30 are respectively not bound as core wire bundles. This allows each of the core wires 11 and each of the core wires 31 to move in a space surrounded by the left mold 2, the right mold 3, the upper mold 4 and the lower mold 5 by a pressure by the upper mold 4. Due to the movement, as illustrated in FIG. 4A, as the exposed core wires 11 and the exposed core wires 31 are shaped into a rectangular cross-sectional shape, each of the core wires 11 and each of the core wires 31 can move to fill the gaps between the core wires 11 of one electric wire 10 and the core wires 11 of the other electric wire 10, between the core wires 31 of one electric wire 30 and the core wires 31 of the other electric wire 30, and between the core wires 11 of each electric wire 10 and the core wires 31 of each electric wire 30, while deforming. As a result, since these gaps are decreased as quickly as possible, the exposed core wires 11 of the two electric wires 10, 10 and the exposed core wires 31 of the two electric wires 30, 30, which are to be joined, can always be uniformly adhered together.

Namely, in a state where the exposed core wires 11, which have been twisted, of the two electric wires 10, 10 are untwisted to be straight and the exposed core wires 31, which have been twisted, of the two electric wires 30, 30 are untwisted to be straight, they are vibrated by ultrasonic to be jointed, which ensures that the exposed core wires 11 and the exposed core wires 31 are joined without breaking of a core wire, fraying of joined core wires, or the like. In addition, even in a state where the material strengths of the core wires 11 differ from the material strengths of the core wires 31, the exposed core wires 11 of the two electric wires 10, 10 and the exposed core wires 31 of the two electric wires 30, 30 can be easily and surely joined together by ultrasonic. In other words, in a state where the two electric wires 10, 10 have the same diameters as the two electric wires 30, 30 and the material strengths of the core wires 11 differ from the material strengths of the core wires 31 (that is, four electric wires are classified into two types in which material strengths of core wires are different under a condition where diameters of electric wires are same), the ultrasonic joining apparatus 1, which has a simple structure in which only the upper mold 4 is reciprocated toward the lower mold 5, can easily and surely join the exposed core wires 11 of the two electric wires 10, 10 and the exposed core wires 31 of the two electric wires 30, 30 together by ultrasonic.

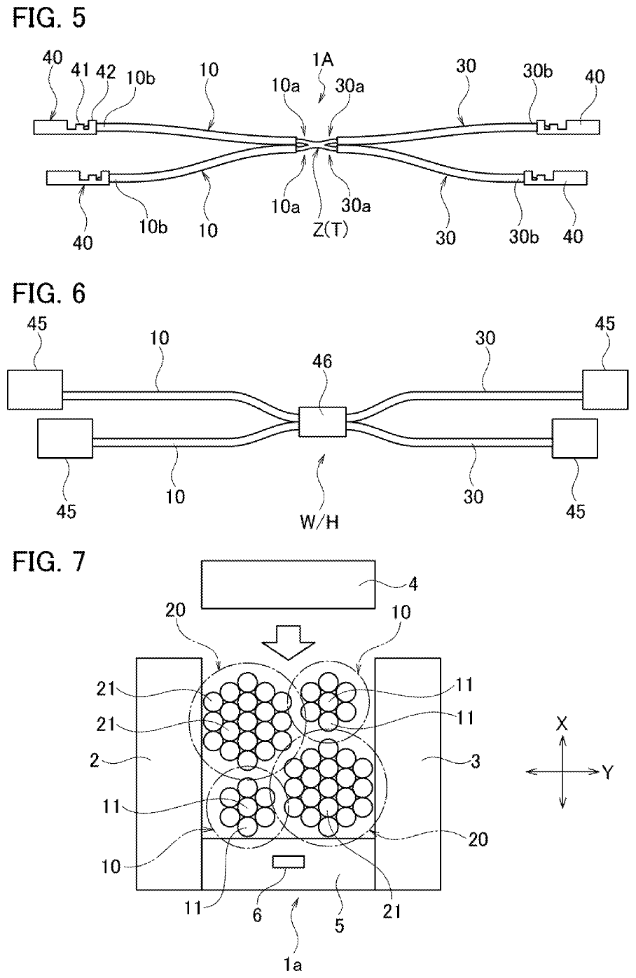

As illustrated in FIG. 5, a joining structure lA of electric wires includes the exposed core wires 11 of the two electric wires 10, 10 and the exposed core wires 31 of the two electric wires 30, 30 which are joined together. Core wire caulking pieces 41 of terminals 40 are respectively caulked and crimped to the core wires 11 of the two electric wires 10, 10 at the other ends 10b, 10b of the two electric wires 10, 10 and to the core wires 31 of the two electric wires 30, 30 at the other ends 30b, 30b of the two electric wires 30, 30, and sheath caulking pieces 42 of the terminals 40 are respectively caulked and crimped to the insulation sheaths 12 of the two electric wires 10, 10 at the other ends 10b, 10b of the two electric wires 10, 10 and to the insulation sheaths 32 of the two electric wires 30, 30 at the other ends 30b, 30b of the two electric wires 30, 30. Then, the tightly joined core wire bundle T at the one ends 10a, 10a of the two electric wires 10, 10 and at the one ends 30a, 30a of the two electric wires 30, 30, which form a branch connection Z of the two electric wires 10, 10 and the two electric wires 30, 30, is covered with a protective member 46 made of synthetic resin. Further, the terminals 40 are mounted to connectors 45. Thereby, as illustrated in FIG. 6, a wiring harness W/H to be wired to a vehicle is completed.

Next, an ultrasonic joining apparatus 1a used in a joining method of electric wires according to a second embodiment will be described.

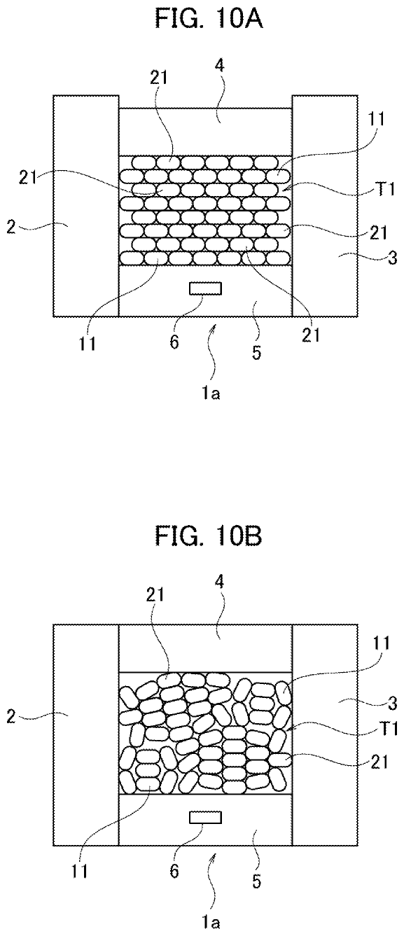

As illustrated in FIG. 7 and FIG. 10A, the ultrasonic joining apparatus 1a includes the pair of the left mold 2 and the right mold 3 and the pair of the upper mold 4 and the lower mold 5. Four core wire bundles which are respectively composed of core wires 11 of one electric wire 10, core wires 11 of the other electric wire 10, core wires 21 of one electric wire 20, and core wires 21 of the other electric wire 20, are held between the left mold 2 and the right mold 3 in the horizontal direction Y, and between the upper mold 4 and the lower mold 5 in the vertical direction X perpendicular to the horizontal direction Y.

In the second exemplary embodiment, the upper mold 4 moves toward the lower mold 5 in a direction approaching the lower mold 5 to apply a pressure to the core wire bundles. The left mold 2 and the right mold 3 are fixed to the lower mold 5. Alternatively, the left mold 2 and the right mold 3 can be configured to move in the horizontal direction Y such that they approach each other on the lower mold 5, to apply a pressure to the core wire bundles. It is noted that the number of the electric wires 10 is not limited to two and the number of the electric wires 20 is not limited to two.

As illustrated in FIG. 7, the piezoelectric vibrator 6 is mounted to the lower mold 5 as ultrasonic joining means. The piezoelectric vibrator 6 to which a voltage is applied by a power supply or the like (not illustrated), vibrates with a frequency of 10 kHz to 80 kHz as ultrasonic vibration, for example. At this time, the piezoelectric vibrator 6 performs ultrasonic joining along the horizontal direction Y or the vertical direction X. It is noted that the ultrasonic joining refers to joining using a vibration obtained by applying a voltage to the piezoelectric vibrator 6 to cause the piezoelectric vibrator 6 to vibrate, that is, by converting electrical energy into mechanical vibrations. The vibration is controlled by a control circuit (not illustrated).

The ultrasonic joining apparatus 1a joins a plurality of core wires 11 of the two electric wires 10, 10 and a plurality of core wires 21 of the two electric wires 20, 20 together. Each of the two electric wires 10, 10 is an aluminum wire having a small diameter with the core wires 11 made of aluminum or aluminum alloy covered with an insulation sheath 12. Each of the two electric wires 20, 20 is an aluminum wire having a large diameter with the core wires 21 made of aluminum or aluminum alloy covered with an insulation sheath 22, and each of the core wires 21 is made of the same material as each of the core wires 11 of the aluminum wires having small diameters (the two electric wires 10, 10). Namely, the ultrasonic joining apparatus 1a joins the plurality of core wires 11 of the two electric wires 10, 10 and the plurality of core wires 21 of the two electric wires 20, 20 together by ultrasonic, in a state where the diameter of each of the two electric wires 10, 10 differs from the diameter of each of the two electric wires 20, 20 and the material strengths of the core wires 11 are the same as the material strengths of the core wires 21.

Next, a procedure of joining the plurality of core wires 11 of the two electric wires 10, 10 and the plurality of core wires 21 of the two electric wires 20, 20 together using the ultrasonic joining apparatus 1a, will be described with reference to FIG. 7 to FIG. 10A.

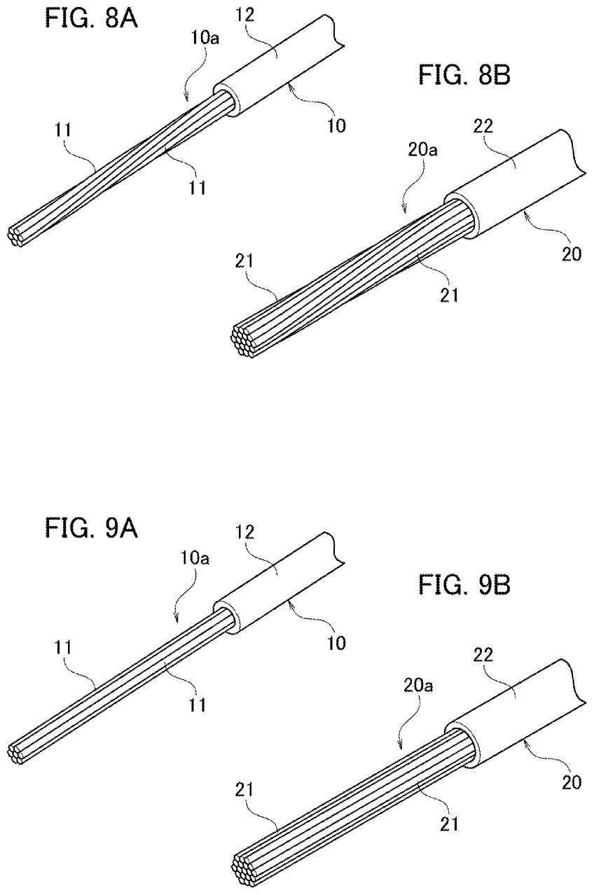

Firstly, as illustrated in FIG. 8A and FIG. 8B, the insulation sheath 12 of each of the two electric wires 10, 10 is peeled off in a little longer, at the one end (part) 10a of each of the two electric wires 10, 10, and the insulation sheath 22 of each of the two electric wires 20, 20 is peeled off in a little longer, at one end (part) 20a of each of the two electric wires 20, 20. Next, as illustrated in FIG. 9A and FIG. 9B, the core wires 11, which have been twisted, exposed at the one end (part) 10a of each the two electric wires 10, 10 are untwisted to be straight, and the core wires 21, which have been twisted, exposed at the one end (part) 20a of each the two electric wires 20, 20 are untwisted to be straight.

Next, as illustrated in FIG. 7, the four core wire bundles which are respectively composed of the straight core wires 11 being untwisted of one electric wire 10, the straight core wires 11 being untwisted of the other electric wire 10, the straight core wires 21 being untwisted of one electric wire 20, and the straight core wires 21 being untwisted of the other electric wire 20, are inserted in a space surrounded by the left mold 2, the right mold 3 and the lower mold 5 from above, and then held between the left mold 2 and the right mold 3. Then, as illustrated in FIG. 10A, the plurality of straight core wires 11 and the plurality of straight core wires 21 are joined to one another by ultrasonic by giving ultrasonic vibration to the plurality of straight core wires 11 and the plurality of straight core wires 21 while applying a pressure to the core wire bundles by moving the upper mold 4 toward the lower mold 5. At this time, since the plurality of straight core wires 11 are untwisted and the plurality of straight core wires 21 are untwisted, each of the core wires 11 and each of the core wires 21 can easily move in a space surrounded by the left mold 2, the right mold 3, the upper mold 4 and the lower mold 5, with comparison with the plurality of core wires 11 having been twisted and the plurality of core wires 21 having been twisted as illustrated in FIG. 10B.

Conventionally, gaps between the core wires 11 of one electric wire 10 and the core wires 11 of the other electric wire 10, between the core wires 21 of one electric wire 20 and the core wires 21 of the other electric wire 20, and between the core wires 11 of each electric wire 10 and the core wires 21 of each electric wire 20, are filled a little by deforming the core wire bundles, as illustrated in FIG. 10B. In contrast, in this embodiment, these gaps are filled by moving and deforming each of the core wires 11 and each of the core wires 21 by applying a pressure to the core wire bundles using the upper mold 4. Thus, vibration can be applied to the plurality of core wires 11 and the plurality of core wires 21 in a state of no more gaps between the core wires 11 of one electric wire 10 and the core wires 11 of the other electric wire 10, between the core wires 21 of one electric wire 20 and the core wires 21 of the other electric wire 20, and between the core wires 11 of each electric wire 10 and the core wires 21 of each electric wire 20 than before. This allows the plurality of core wires 11 and the plurality of core wires 21 to be joined into a bundle-like rectangular cross-sectional shape (uniformly adhered core wire bundle T1) with no gaps, as quickly as possible. In addition, vibration is transmitted evenly to each of the core wires 11 and each of the core wires 21, which ensures that the plurality of core wires 11 and the plurality of core wires 21 are joined without breaking of a core wire, fraying of j oined core wires, or the like.

As described above, in a case where the diameters of the two electric wires 10, 10 differ from the diameters of the two electric wires 20, 20 and the material strengths of the core wires 11 are the same as the material strengths of the core wires 31, the conventional method deforms each of the core wires 11 and each of the core wires 21 by applying a pressure to the core wire bundles using the upper mold 4 or applying a pressure to the core wire bundles before joining the core wires 11 and the core wires 21 together. However, since the exposed core wires 11 of each electric wire 10 have been twisted and the exposed core wires 21 of each electric wire 20 have been twisted, the core wires 11 of each electric wire 10 and the core wires 21 of each electric wire 20 have been respectively bound as core wire bundles. Due to this, as illustrated in FIG. 10B, gaps between the core wires 11 and the core wires 21 easily occur.

In contrast, in this embodiment, since the exposed core wires 11 of each electric wire 10 are untwisted to be straight and the exposed core wires 21 of each electric wire 20 are untwisted to be straight, the core wires 11 of each electric wire 10 and the core wires 21 of each electric wire 20 are respectively not bound as core wire bundles. This allows each of the core wires 11 and each of the core wires 21 to move in a space surrounded by the left mold 2, the right mold 3, the upper mold 4 and the lower mold 5 by a pressure by the upper mold 4. Due to the movement, as illustrated in FIG. 10A, as the exposed core wires 11 and the exposed core wires 21 are shaped into a rectangular cross-sectional shape, each of the core wires 11 and each of the core wires 21 can move to fill the gaps between the core wires 11 of one electric wire 10 and the core wires 11 of the other electric wire 10, between the core wires 21 of one electric wire 20 and the core wires 21 of the other electric wire 20, and between the core wires 11 of each electric wire 10 and the core wires 21 of each electric wire 20, while deforming. As a result, since these gaps are decreased as quickly as possible, the exposed core wires 11 of the two electric wires 10, 10 and the exposed core wires 21 of the two electric wires 20, 20, which are to be joined, can always be uniformly adhered to together.

Namely, in a state where the exposed core wires 11, which have been twisted, of the two electric wires 10, 10 are untwisted to be straight and the exposed core wires 21, which have been twisted, of the two electric wires 20, 20 are untwisted to be straight, they are vibrated by ultrasonic to be jointed, which ensures that the exposed core wires 11 and the exposed core wires 21 are joined without breaking of a core wire, fraying of joined core wires, or the like. In addition, even in a state where the diameters of the two electric wires 10, 10 differ from the diameters of the two electric wires 20, 20, the exposed core wires 11 of the two electric wires 10, 10 and the exposed core wires 21 of the two electric wires 20, 20 can be easily and surely joined together by ultrasonic. In other words, in a state where the diameters of the two electric wires 10, 10 differ from the diameters of the two electric wires 20, 20 and the material strengths of the core wires 11 are the same as the material strengths of the core wires 31 (that is, four electric wires are classified into two types in which diameters of electric wires are different under a condition where material strengths of core wires are same), the ultrasonic joining apparatus 1a, which has a simple structure in which only the upper mold 4 is reciprocated toward the lower mold 5, can easily and surely join the exposed core wires 11 of the two electric wires 10, 10 and the exposed core wires 21 of the two electric wires 20, 20 together by ultrasonic.

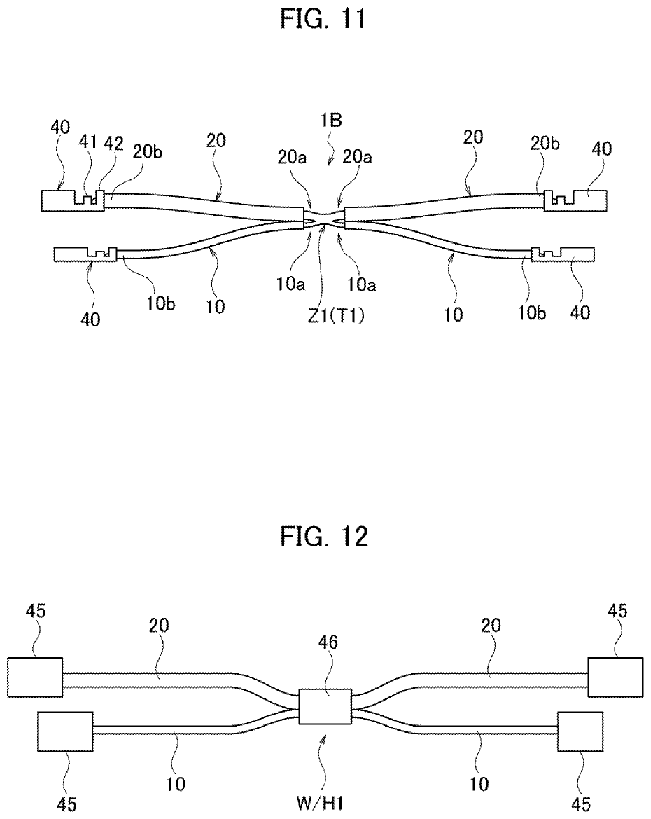

As illustrated in FIG. 11, a joining structure of electric wires 1B includes the exposed core wires 11 of the two electric wires 10, 10 and the exposed core wires 21 of the two electric wires 20, 20 which are joined together. The core wire caulking pieces 41 of the terminals 40 are respectively caulked and crimped to the core wires 11 of the two electric wires 10, 10 at the other ends 10b, 10b of the two electric wires 10, 10 and to the core wires 21 of the two electric wires 20, 20 at the other ends 20b, 20b of the two electric wires 20, 20, and the sheath caulking pieces 42 of the terminals 40 are respectively caulked and crimped to the insulation sheaths 12 of the two electric wires 10, 10 at the other ends 10b, 10b of the two electric wires 10, 10 and to the insulation sheaths 22 of the two electric wires 20, 20 at the other ends 20b, 20b of the two electric wires 20, 20. Then, the tightly joined core wire bundle T1 at the one ends 10a, 10a of the two electric wires 10, 10 and at the one ends 20a, 20a of the two electric wires 20, 20, which form a branch connection Z1 of the two electric wires 10, 10 and the two electric wires 20, 20, is covered with the protective member 46 made of synthetic resin. Further, the terminals 40 are mounted to connectors 45. Thereby, as illustrated in FIG. 12, a wiring harness W/H1 to be wired to a vehicle is completed.

The present embodiments are not limited to the above-described explanations. Various modifications are possible within the scope of the gist of the embodiments.

According to each of the embodiments, the core wires being exposed and untwisted to be straight at one end of one electric wire and the core wires being exposed and untwisted to be straight at one end of each of the other electric wires are joined together in a bundle. The core wires being exposed and untwisted to be straight at a middle part (part) of one electric wire and the core wires being exposed and untwisted to be straight at a middle part (part) of each of the other electric wires may be joined together in a bundle.

According to each of the embodiments, the core wires of four electric wires are joined together by ultrasonic. Core wires of two or three electric wires may be joined together by ultrasonic.

According to the second embodiment, the core wires of four electric wires (aluminum wires) made of aluminum or aluminum alloy are joined together by ultrasonic. Core wires of four electric wires (copper wires) made of copper or copper alloy may be joined together by ultrasonic.

According to each of the embodiments, the electric wires are classified into two types. The electric wires may be classified into three or more types.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A joining method of electric wires comprising:
peeling off an insulation sheath of each of a plurality of electric wires at a part of each of the electric wires to expose core wires having been twisted of each of the electric wires;
untwisting the exposed core wires of each of the electric wires; and
joining untwisted core wires of the electric wires together in a bundle.

2. The joining method of electric wires according to claim 1,
wherein the electric wires are classified into two or more types in which material strengths of core wires are different under a condition where diameters of electric wires are same, and
the untwisted core wires of the electric wires are joined together in a bundle by giving ultrasonic vibration to the untwisted core wires of the electric wires.

3. The joining method of electric wires according to claim 1,
wherein the electric wires are classified into two or more types in which diameters of electric wires are different under a condition where material strengths of core wires are same, and
the untwisted core wires of the electric wires are joined together in a bundle by giving ultrasonic vibration to the untwisted core wires of the electric wires.

4. The joining method of electric wires according to claim 1,
wherein the insulation sheath of each of the plurality of electric wires at one end of each of the electric wires is peeled off to expose the core wires having been twisted of each of the electric wires,
the untwisted core wires of the electric wires are joined together in a bundle by giving ultrasonic vibration to the untwisted core wires of the electric wires.

5. A joining structure of electric wires comprising:
a plurality of electric wires each of which includes core wires being exposed at a part of each of the electric wires by peeling off an insulation sheath of each of the electric wires at the part of each of the electric wires and being untwisted,
wherein untwisted core wires of the electric wires are joined together in a bundle.

6. The joining structure of electric wires according to claim 5,
wherein the electric wires are classified into two or more types in which material strengths of core wires are different under a condition where diameters of electric wires are same, and
the untwisted core wires of the electric wires are joined together in a bundle by giving ultrasonic vibration to the untwisted core wires of the electric wires.

7. The joining structure of electric wires according to claim 5,
wherein the electric wires are classified into two or more types in which diameters of electric wires are different under a condition where material strengths of core wires are same, and
the untwisted core wires of the electric wires are joined together in a bundle by giving ultrasonic vibration to the untwisted core wires of the electric wires.

8. The joining structure of electric wires according to claim 5,
wherein the core wires are exposed at one end of each of the electric wires by peeling off the insulation sheath at the one end of each of the electric wires, and
the untwisted core wires of the electric wires are joined together in a bundle by giving ultrasonic vibration to the untwisted core wires of the electric wires.
